(19) United States
(12) Patent Application Publication
(10) Pub. No.: US 2026/0352744 A1
(43) Pub. Date: Nov. 5, 2026

(54) system and method for dynamically adjusting network settings to improve performance of a computing system

(71) Applicant: Bank of America Corporation, Charlotte, NC (US)

(72) Inventors: Jemlin Lucas, Coppell, TX (US); Suryanarayana Adivi, Hyderabad (IN); Durga Prasad Kutthumolu, Hyderabad (IN); Pushkar Taneja, Hyderabad (IN)

(21) Appl. No.: 19/184,066

(22) Filed: Apr. 21, 2025

(51) Int. Cl. H04L 67/63; H04L 9/40; H04L 41/142; H04L 43/0817; H04L 67/1036

(52) U.S. Cl. CPC H04L 67/63; H04L 41/142; H04L 43/0817; H04L 63/1441; H04L 67/1036

(57) ABSTRACT

A first single board computer deployed at a first server determines a first performance status of a first server based on the performance data relating to the first server and electronically transmits the first performance status of the first server to a first network switch. A second single board computer deployed at the first network switch receives the first performance status of the first server and determines, based on the first performance status of the first server, that the first server has experienced a performance anomaly. The second single board computer receives a first request to perform a first processing task as part of a first data interaction, and in response, causes the first network switch to route the first request to a second server that is also configured to perform the first processing task.

### TECHNICAL FIELD

The present disclosure relates generally to network communication, and more specifically to a system and method for dynamically adjusting network settings to improve performance of a computing system.

### BACKGROUND

Monitoring the performance of a computing system is crucial for ensuring its optimal operation, consistency, and efficiency. By continuously tracking key performance metrics such as CPU utilization, memory usage, disk I/O, and network bandwidth, potential issues may be detected before they escalate into serious problems. However, conventional monitoring systems are slow and often unable to detect and fix performance issues before they cause damage to the computing system.

### SUMMARY

Embodiments of the present disclosure provide technical solutions to the technical problems noted above by providing techniques for detecting and resolving performance issues in a computing system promptly and accurately.

Several performance anomalies may occur in a computing infrastructure that may adversely affect performance of the computing infrastructure and its components (e.g., servers). Performance anomalies in computing systems refer to situations where the system does not behave as expected, often resulting in degradation or instability in system performance. These anomalies can manifest in various ways and may be caused by hardware or software issues. In some cases, these performance anomalies may be caused by security breaches in the computing system. Example performance anomalies that may occur in a computing system include, but are not limited to, CPU bottlenecks caused by CPU overload, memory leaks, disk input/output (I/O) bottlenecks, high network latency, high device heat, cache misses, database lock contention, and overloaded network interface.

Some of the performance anomalies that occur in a computing system may be caused by security breaches of the computing system. A security breach, often referred to as a cyber-attack, in a computing system generally refers to an incident where unauthorized individuals, applications, or entities gain access to sensitive data, systems, or resources within an organization's computing infrastructure. In one example, a security breach may include unauthorized installing of malicious software code (e.g., malware) at a computing device (e.g., server), wherein the malicious software is configured to perform malicious activities to disrupt an operation of the computing device, for example, by creating unwanted files to slow down the speed and performance of the computing device, corrupting files, or crashing some software or executable applications so that they cannot be executed.

Malware can infect many types of devices, including cell phones, computers, tables, and smart televisions. It usually spreads by duplicating itself and hiding in a device's data files. A malware attack often results in compromised computing performance by causing slow processor performance, browser redirects, frequent infection warnings, frequent pop-up ads, problems starting up and shutting down a computing node, sudden loss of memory disk space, repeated system crashes and freezes, disabled security features, changes in file name and sizes, programs opening and closing themselves, or a combination thereof. In some cases, a malware locks up networks and computing nodes (e.g., servers) making them unusable.

Conventional computing systems are generally unable to detect and resolve performance anomalies that occur in the computing system accurately and promptly before the anomalies escalate into serious problems and cause damage to the computing systems. For example, conventional computing systems employ a central monitoring/processing entity (e.g., a central monitoring server) that monitors performance data of the entire computing system, determines any performance anomalies, determines remediation measures that are to be applied to resolve the anomalies, and applies the determined remediation measures at the appropriate systems to resolve the anomalies. In such systems, performance related data from each server on the computing network is routed to the central monitoring entity which analyzes the data and detects performance/security issues in the system/network. This means that performance data often travels long distances before reaching the central monitoring entity, which introduces data communication delays. Because performance data from across the computing network must travel to the central monitoring server and all analysis of the performance data occurs at the single central entity, the current monitoring systems are slow and cannot detect and resolve issues promptly. Further, the central entity must handle all processing associated with analyzing the performance data received from all servers to determine whether an anomaly has occurred, determine an appropriate remediation method and apply the remediation method to appropriate system to resolve anomalies. This high processing load on a single processing entity further slows down the process of detection and resolution of performance issues.

Embodiments of the present disclosure describe an improved system and method for detecting and resolving performance related issues that occur in a computing network accurately and promptly (e.g., in real-time or near-real time). As Embodiments of the present disclosure describe a distributed processing mechanism where processing responsibilities (e.g., monitoring and analyzing performance data, determining and applying resolutions) are distributed across the computing network. For example, the monitoring and analyzing of performance data is carried out locally at each server. Further, the determination and application of resolutions is performed at the network switch level. As described in embodiments of the present disclosure, servers of a computing infrastructure are logically divided into a plurality of server groups. Every server that belongs to a particular server group is configured to perform the same processing task and servers belonging to different server groups are configured to perform different processing tasks. Servers of each server group are served by a dedicated network switch. A network switch associated with a particular server group is configured to selectively route processing requests and other data to servers that belong to the particular server group. A single board computer is locally deployed at each server and each network switch. Each single board computer is essentially a fully functional computer typically implemented on a single printed circuit board, so it can run various types of software, including operating systems, applications, and development tools. Each single board computer deployed at a respective server monitors performance data associated with the respective server and determines a performance status of the respective server. The determined performance status of the server is then transmitted to the respective network switch of the server group to which the server belongs.

The single board computer deployed at the network switch receives the performance status of each server and determines whether the server has experienced a performance anomaly. If a performance anomaly is detected, the single board computer causes the network switch to route processing requests to an alternate server in the same server group that has not experienced a performance anomaly.

By distributing processing responsibilities associated with monitoring performance data, determining issues, and applying resolutions, the disclosed system and method improves the speed with which anomalies may be detected and fixed. For example, locally analyzing performance data at each server 104 avoids delays that would otherwise be incurred in transmitting the performance data to a central monitoring/processing entity, thus, significantly increasing the speed of determining anomalies. Further, determining and applying resolutions to detected anomalies at each network switch level also improves the speed of applying resolutions. Detecting and resolving performance anomalies that occur in a computing system promptly and accurately improves performance of the computing network. For example, promptly detecting a performance anomaly and routing processing requests to an alternative server improves system throughput which would otherwise have dropped if processing requests were continued to be routed to the anomalous server. Further, by stopping processing of tasks at an anomalous server, further damage to the anomalous systems is avoided. Thus, the disclosed system and method improve the overall performance of computing systems.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a system, in accordance with certain aspects of the present disclosure;

FIG. 2 illustrates an example schematic diagram of the central server shown in FIG. 1, in accordance with one or more aspects of the present disclosure;

FIG. 3 illustrates an example schematic diagram of a single board computer deployed at a server shown in FIG. 1, in accordance with one or more aspects of the present disclosure;

FIG. 4 illustrates an example schematic diagram of a single board computer deployed at a network switch shown in FIG. 1, in accordance with one or more aspects of the present disclosure; and

FIG. 5 illustrates a flowchart of an example method for detecting and resolving performance anomalies and security breaches in a computing infrastructure, in accordance with certain embodiments of the present disclosure.

### DETAILED DESCRIPTION

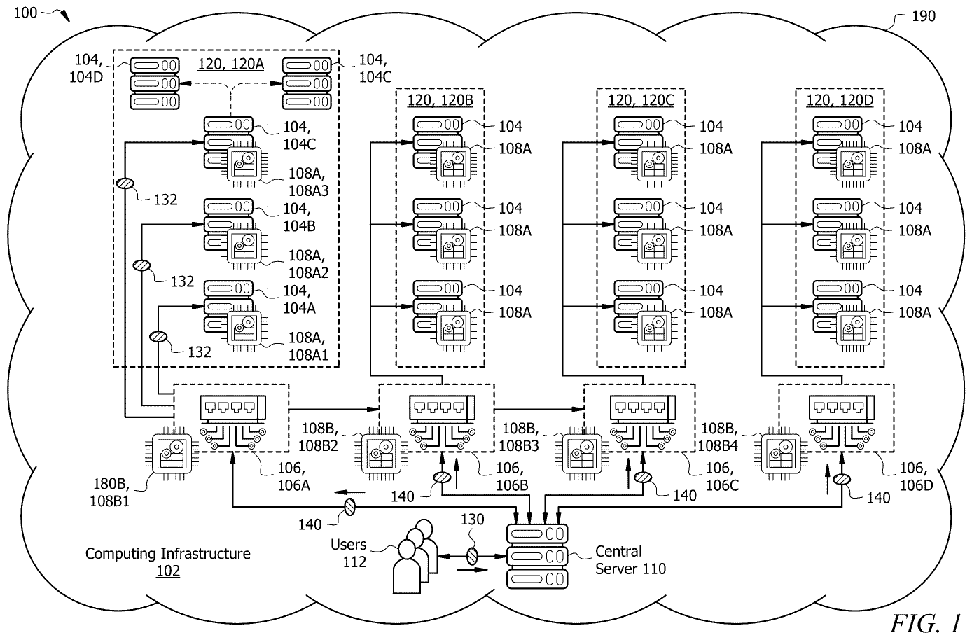

FIG. 1 is a schematic diagram of an example system 100, in accordance with certain aspects of the present disclosure. As shown, system 100 includes a computing infrastructure 102 connected to a network 190. Computing infrastructure 102 may include several hardware and software components. For example, as shown in FIG. 1, computing infrastructure 102 may include a plurality of servers 104, a plurality of network switches 106, a plurality of single board computers 108, and a central server 110 connected to the network 190. Other hardware components not shown in FIG. 1 may include, but are not limited to, computing nodes such as desktop computers, smartphones, tablet computers, laptop computers, data servers and data centers, mainframe computers, virtual reality (VR) headsets, augmented reality (AR) glasses and other hardware devices such as printers, routers, hubs, switches, and memory all connected to the network 190. Software components may include software applications that are run by one or more of the computing nodes (e.g., servers 104, network switches 106, single board computers 108, and central server 110), but not limited to, operating systems, user interface applications, third party software, database management software, service management software, mainframe software, metaverse software, AI tools and other customized software programs implementing particular functionalities. For example, software code relating to one or more software applications may be stored in a memory device and one or more processors (e.g., belonging to one or more computing nodes) may execute the software code to implement respective functionalities. In one embodiment, at least a portion of the computing infrastructure 102 may be representative of an Information Technology (IT) infrastructure of an organization.

One or more of the computing nodes (e.g., servers 104, network switches 106, single board computers 108, and central server 110), may be operated by a user 112. In this context, a computing node operated by a user may be referred to as a user device. For example, a computing node may provide a user interface using which a user may operate the computing node to perform data interactions within the computing infrastructure.

One or more computing nodes (e.g., servers 104, network switches 106, single board computers 108, and central server 110) of the computing infrastructure 102 may be representative of a computing system which hosts software applications that may be installed and run locally or may be used to access software applications running on a server. The computing system may include mobile computing systems including smart phones, tablet computers, laptop computers, or any other mobile computing devices or systems capable of running software applications and communicating with other devices. The computing system may also include non-mobile computing devices such as desktop computers or other non-mobile computing devices capable of running software applications and communicating with other devices. In certain embodiments, one or more of the computing nodes may be representative of a server running one or more software applications to implement respective functionality as described below. In certain embodiments, one or more of the computing nodes may run a thin client software application where the processing is directed by the thin client but largely performed by a central entity such as a server (not shown).

Network 190, in general, may be a wide area network (WAN), a personal area network (PAN), a cellular network, or any other technology that allows devices to communicate electronically with other devices. In one or more embodiments, network 190 may be the Internet.

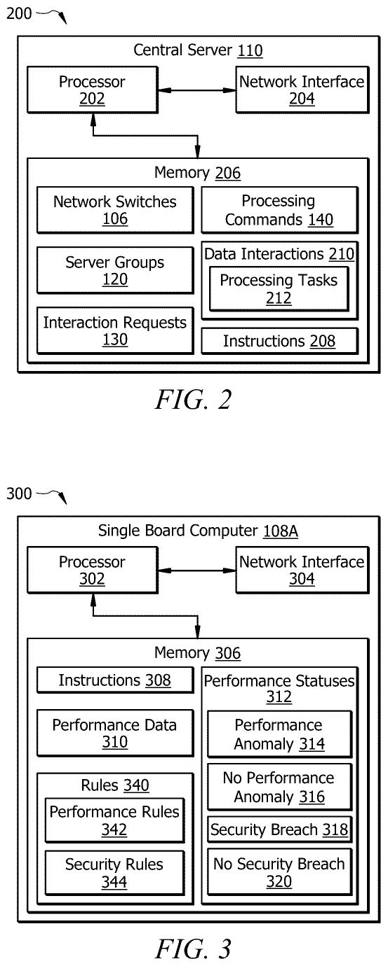

Several data interactions (e.g., data interactions 210 shown in FIG. 2) may be performed in the computing infrastructure 102. Some of these data interactions 210 may be initiated by a user 112. Other data interactions 210 may be automatically initiated by a computing node (e.g., central server 110) of the computing infrastructure (e.g., machine-initiated). Data interactions 210 that may be performed in the computing infrastructure 102 may include accessing data stored in a memory device (e.g., database or server) of the computing infrastructure 102, transmission of data between computing nodes of the computing infrastructure 102, logging into a user profile (e.g., a social media profile, a content streaming profile, an email profile etc.) by a user 112 to gain access to data (e.g., social media data feed, video content, emails etc.) stored on a respective data server, modifying data stored at a server, requesting a piece of data stored on a database or server of the computing infrastructure 102 and receiving the requested data at a user device.

Each data interaction 210 performed in the computing infrastructure 102 typically includes one or more processing tasks 212 (shown in FIG. 2) that may need to be performed in a sequence or at least partially in parallel to complete the data interaction 210. Example processing tasks 212 that may need to be performed as part of performing data interactions 210 may include, but are not limited to, data capture and validation, user authentication, user authorization, interaction processing (e.g., data transformation, logic execution etc.), database interactions, security measures (e.g., encryption, fraud detection etc.), interaction approvals, communication with external systems, and confirmation and notification.

Several performance anomalies may occur in the computing infrastructure 102 that may adversely affect performance of the computing infrastructure 102 and its components (e.g., servers 104). Performance anomalies in computing systems (e.g., computing infrastructure 102) refer to situations where the system does not behave as expected, often resulting in degradation or instability in system performance. These anomalies can manifest in various ways and may be caused by hardware or software issues. In some cases, these performance anomalies may be caused by security breaches in the computing system. Example performance anomalies that may occur in a computing system include, but are not limited to, CPU bottlenecks caused by CPU overload, memory leaks, disk input/output (I/O) bottlenecks, high network latency, high device heat, cache misses, database lock contention, and overloaded network interface.

Some of the performance anomalies that occur in a computing system may be caused by security breaches of the computing system. A security breach, often referred to as a cyber-attack, in a computing system generally refers to an incident where unauthorized individuals, applications, or entities gain access to sensitive data, systems, or resources within an organization's computing infrastructure. In one example, a security breach may include unauthorized installing of malicious software code (e.g., malware) at a computing device (e.g., server 104), wherein the malicious software is configured to perform malicious activities to disrupt an operation of the computing device, for example, by creating unwanted files to slow down the speed and performance of the computing device, corrupting files, or crashing some software or executable applications so that they cannot be executed.

Malware can infect many types of devices, including cell phones, computers, tables, and smart televisions. It usually spreads by duplicating itself and hiding in a device's data files. A malware attack often results in compromised computing performance by causing slow processor performance, browser redirects, frequent infection warnings, frequent pop-up ads, problems starting up and shutting down a computing node, sudden loss of memory disk space, repeated system crashes and freezes, disabled security features, changes in file name and sizes, programs opening and closing themselves, or a combination thereof. In some cases, a malware locks up networks and computing nodes (e.g., servers 104) making them unusable.

Conventional computing systems are generally unable to detect and resolve performance anomalies that occur in the computing system accurately and promptly before the anomalies escalate into serious problems and cause damage to the computing systems. For example, conventional computing systems (e.g., computing infrastructure 102) employ a central monitoring/processing entity (e.g., a central monitoring server) that monitors performance data of the entire computing system, determines any performance anomalies, determines remediation measures that are to be applied to resolve the anomalies, and applies the determined remediation measures at the appropriate systems to resolve the anomalies. In such systems, performance related data from each server on the computing network is routed to the central monitoring entity which analyzes the data and detects performance/security issues in the system/network. This means that performance data often travels long distances before reaching the central monitoring entity, which introduces data communication delays. Because performance data from across the computing network must travel to the central monitoring server and all analysis of the performance data occurs at the single central entity, the current monitoring systems are slow and cannot detect and resolve issues promptly. Further, the central entity must handle all processing associated with analyzing the performance data received from all servers to determine whether an anomaly has occurred, determine an appropriate remediation method and apply the remediation method to appropriate system to resolve anomalies. This high processing load on a single processing entity further slows down the process of detection and resolution of performance issues.

Embodiments of the present disclosure describe an improved system and method for detecting and resolving performance related issues that occur in a computing network (e.g., computing infrastructure 102) accurately and promptly (e.g., in real-time or near-real time). As further described below, embodiments of the present disclosure describe a distributed processing mechanism where processing responsibilities (e.g., monitoring and analyzing performance data, determining and applying resolutions) are distributed across the computing network. For example, the monitoring and analyzing of performance data is carried out locally at each server 104. Further, the determination and application of resolutions is performed at the network switch level. By distributing processing responsibilities associated with monitoring performance data, determining issues, and applying resolutions, the disclosed system and method improves the speed with which anomalies may be detected and fixed. For example, locally analyzing performance data at each server 104 avoids delays that would otherwise be incurred in transmitting the performance data to a central monitoring/processing entity, thus, significantly increasing the speed of determining anomalies. Further, determining and applying resolutions to detected anomalies at each network switch level also improves the speed of applying resolutions.

As shown in FIG. 1, the servers 104 of the computing infrastructure 102 are logically divided into a plurality of server groups 120. As shown, the example computing infrastructure 102 includes four server groups labeled as 120a, 120b, 120c and 120d. Each server group 120 includes a plurality of servers 104. For example, server group 120a includes servers 104a, 104b, 104c, 104d, and 104e. Every server 104 that belongs to a particular server group 120 is configured to perform the same processing task 212 (shown in FIG. 2). As described above, each data interaction 210 performed in the computing infrastructure 102 typically includes one or more processing tasks 212 that may need to be performed in a sequence or at least partially in parallel to complete the data interaction 210. For example, each server 104 that belongs to the server group 120a may be configured to perform a same first processing task 212. In one embodiment, servers 104 belonging to different server groups 120 are configured to perform different processing tasks 212. For example, servers 104 of server group 120b may be configured to perform a second processing task 212, servers 104 of server group 120c may be configured to perform a third processing task 212, and servers 104 of server group 120d may be configured to perform a fourth processing task, wherein the first, second, third and fourth processing tasks are different from each other.

As shown in FIG. 1, servers 104 of each server group 120 are served by a dedicated network switch 106. For example, server group 120a is served by network switch 106a, server group 120b is served by network switch 106b, server group 120c is served by network switch 106c, and server group 120d is served by network switch 106d. A network switch 106 associated with a particular server group 120 is configured to selectively route processing requests 132 and other data to servers 104 that belong to the particular server group 120, wherein the processing requests 132 relate to the particular processing task 212 the servers 104 of the particular server group 120 are configured to perform. For example, network switch 106a is configured to selectively route processing requests 132 for the first processing task 212 and other data to servers 104a-e of the server group 120a. Similarly, network switch 106b is configured to selectively route processing requests 132 for the second processing task 212 and other data to servers 104 of the server group 120b. Network switch 106c is configured to selectively route processing requests 132 for the third processing task 212 and other data to servers 104 of the server group 120c. Network switch 106d is configured to selectively route processing requests 132 for the fourth processing task 212 and other data to servers 104 of the server group 120d.

As shown in FIG. 1, a single board computer 108 is locally deployed at each server 104 and each network switch 106. Each single board computer 108 is essentially a fully functional computer typically implemented on a single printed circuit board, so it can run various types of software, including operating systems, applications, and development tools. This means that each single board computer 108 is an independent processing entity from the respective server 104/network switch 106 where it is deployed. Typical components of a single board computer 108 may include, but are not limited to, a processor, network interface including communication ports for communication with external devices and systems, general purpose input/output (GIPO) pins that allow connectivity to control sensors motors, LEDs and other electronic components, and storage allowing storage of data, operating system and other custom software. In one example, one or more single board computers 108 may be implemented using a Rasberry Pi board or Arduino board.

As shown, single board computers 108 deployed at servers 104 are labeled 108A and single board computers 108 deployed at network switches 106 are labeled 108B. For example, single board computers 108A1, 108A2, and 108A3 are deployed at servers 104a, 104b, and 104c respectively. Similarly, single board computers 108B1, 108B2, 108B3, and 108B4 are deployed at network switches 106a, 106b, 106c and 106d respectively. Local deployment of a single board computer 108 at a respective server 104/network switch 106 means that the single board computer 108 may be housed inside an outer casing/cover of the server 104/network switch 106 or within close proximity of the server 104/network switch 106 such that data travel times between the single board computer 108 and the respective server 104/network switch 106 are negligible (e.g., real time or near real time). In the context of the present disclosure, each single board computer is a custom computer configured to implement a custom functionality as further described below.

As shown in FIG. 1, computing infrastructure 102 includes central server 110 that is configured to coordinate processing of data interactions 210 performed in the computing infrastructure 102.

FIG. 2 illustrates an example schematic diagram 200 of the central server 110 shown in FIG. 1, in accordance with one or more aspects of the present disclosure.

The central server 110 comprises a processor 202, a memory 206, and a network interface 204. The central server 110 may be configured as shown in FIG. 2 or in any other suitable configuration.

The processor 202 includes one or more processors operably coupled to the memory 206. The processor 202 is any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor 202 may be a programmable logic device, a microcontroller, a microprocessor, or any suitable combination of the preceding. The processor 202 is communicatively coupled to and in signal communication with the memory 206. The one or more processors are configured to process data and may be implemented in hardware or software. For example, the processor 202 may be 8-bit, 16-bit, 32-bit, 64-bit or of any other suitable architecture. The processor 202 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

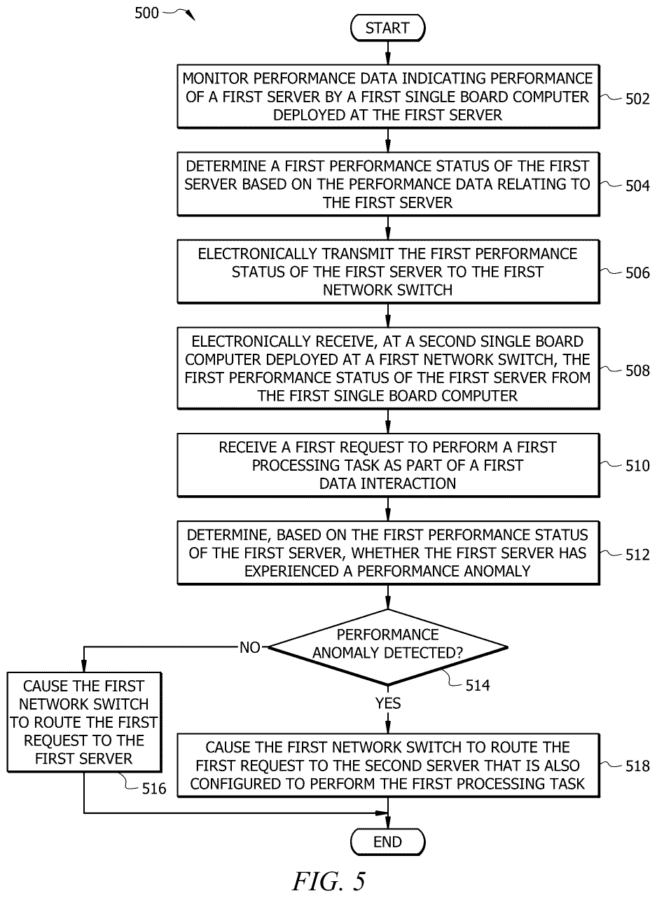

The one or more processors are configured to implement various instructions, such as software instructions. For example, the one or more processors are configured to execute instructions 208 to implement the central server 110. In this way, processor 202 may be a special-purpose computer designed to implement the functions disclosed herein. In one or more embodiments, the central server 110 is implemented using logic units, FPGAs, ASICs, DSPs, or any other suitable hardware. The central server 110 is configured to operate as described with reference to FIGS. 1, 2, and 5. For example, the processor 202 may be configured to perform at least a portion of method 500 as described with reference to FIG. 5.

The memory 206 includes a non-transitory computer-readable medium such as one or more disks, tape drives, or solid-state drives, and may be used as an over-flow data storage device, to store programs when such programs are selected for execution, and to store instructions and data that are read during program execution. The memory 206 may be volatile or non-volatile and may include a read-only memory (ROM), random-access memory (RAM), ternary content-addressable memory (TCAM), dynamic random-access memory (DRAM), and static random-access memory (SRAM).

The memory 206 is operable to store the instructions 208, information relating to data interactions 210 including respective processing tasks 212 that may be performed in the computing infrastructure 102, interaction requests 130, processing commands 140, information relating to various server groups 120 and processing task performed by each server group, information relating to network switches 106 serving each server group 120, and any other data needed to performed operations of the central server 110 as described in embodiments of the present disclosure. The instructions 208 may include any suitable set of instructions, logic, rules, or code operable to execute the central server 110.

The network interface 204 is configured to enable wired and/or wireless communications. The network interface 204 is configured to communicate data between the central server 110 and other devices, systems, or domains (e.g., servers 104, network switches 106 etc.). For example, the network interface 204 may include a Wi-Fi interface, a LAN interface, a WAN interface, a modem, a switch, or a router. The processor 202 is configured to send and receive data using the network interface 204. The network interface 204 may be configured to use any suitable type of communication protocol as would be appreciated by one of ordinary skill in the art.

It may be noted that each of the servers 104 and network switches 106 may be implemented like the central server 110 shown in FIG. 2. For example, each of the servers 104 and network switches 106 may have a respective processor and a memory that stores data and instructions to perform a respective functionality of the servers 104 and network switches 106.

In operation, central server 110 may be configured to receive interaction requests 130 for performing data interactions 210. The interaction requests 130 may be received from users 112 or may be machine-initiated. For example, a user 112 may initiate a particular data interaction 210 from a user interface on a user device (now shown) which may cause the user device to send an interaction request 130 for the particular data interaction 210 to the central server 110. In response to receiving the interaction request 130 for a particular data interaction 210, central server 110 may access the processing tasks 212 that need to be completed to perform the requested data interaction 210. Once, the processing tasks 212 needed to performed are determined, central server 110 identifies a server group 120 that is configured to perform each processing task 212 and a corresponding network switch 106 that serves the server group 120. For example, central server 110 may determine that a first processing task 212 and a third processing task 212 need to performed to complete the requested data interaction. Thereafter, central server 110 may determine that server group 120a is configured to perform the first processing task 212 and server group 120c is configured to perform the third processing task 212. Additionally, central server 110 determines that network switch 106a is associated with server group 120a and network switch 106c is associated with server group 120c.

After identifying the server groups 120 and respective network switches 106 for each processing task 212, central server 110 may transmit processing commands 140 to each identified network switch 106 for an identified processing task 212 the respective server group 120 is configured to perform. For example, central server 110 transmits a processing command 140 to network switch 106a for performing the first processing task and transmits a processing command 140 to network switch 106c for performing the third processing task. As described in more detail below, in response to receiving a processing command 140 from the central server, a network switch 106 selects one or more servers 104 in from the respective server group 120 and transmits a processing request 132 to the selected one or more servers 104 to perform the processing task 212. For example, in response to receiving a processing command 140 to perform the first processing task 212, network switch 106a may select one of the servers 104a-c and transmit a processing request 132 to the selected server 104 to perform the first processing task 212. Once the processing task 212 is completed by the selected one or more servers 104 of a server group 120, results from completing the processing task 212 are transmitted back to the central server 110 via the respective network switch 106. For example, once a selected server 104a-c of the server group 120a completes the first processing task 212, the selected server 104a-c forwards results from the completion of the first processing task 212 back to the network switch 106a which then forwards the same to the central server 110.

In one or more embodiments, each single board computer 108A deployed at a respective server 104 may be configured to monitor performance data 310 associated with the respective server 104 and determine a performance status 312 of the respective server 104.

FIG. 3 illustrates an example schematic diagram 300 of a single board computer 108A deployed at a server 104 shown in FIG. 1, in accordance with one or more aspects of the present disclosure.

The single board computer 108A comprises a processor 302, a memory 306, and a network interface 304. The single board computer 108A may be configured as shown in FIG. 3 or in any other suitable configuration.

The processor 302 includes one or more processors operably coupled to the memory 306. The processor 302 is any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor 302 may be a programmable logic device, a microcontroller, a microprocessor, or any suitable combination of the preceding. The processor 302 is communicatively coupled to and in signal communication with the memory 306. The one or more processors are configured to process data and may be implemented in hardware or software. For example, the processor 302 may be 8-bit, 16-bit, 32-bit, 64-bit or of any other suitable architecture. The processor 302 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

The one or more processors are configured to implement various instructions, such as software instructions. For example, the one or more processors are configured to execute instructions 308 to implement the single board computer 108A. In this way, processor 302 may be a special-purpose computer designed to implement the functions disclosed herein. In one or more embodiments, the single board computer 108A is implemented using logic units, FPGAs, ASICs, DSPs, or any other suitable hardware. The single board computer 108A is configured to operate as described with reference to FIGS. 1, 3, and 5. For example, the processor 302 may be configured to perform at least a portion of method 500 as described with reference to FIG. 5.

The memory 306 includes a non-transitory computer-readable medium such as one or more disks, tape drives, or solid-state drives, and may be used as an over-flow data storage device, to store programs when such programs are selected for execution, and to store instructions and data that are read during program execution. The memory 306 may be volatile or non-volatile and may include a read-only memory (ROM), random-access memory (RAM), ternary content-addressable memory (TCAM), dynamic random-access memory (DRAM), and static random-access memory (SRAM).

The memory 306 is operable to store the instructions 308, performance data 310 associated with the respective server 104 at which the single board computer 108A is deployed, performance statuses 312 (e.g., performance anomaly 314, no performance anomaly 316, security breach 318, no security breach 320) of the respective server 104 at which the single board computer 108A is deployed, rules 340 (e.g., performance rules 342 and security rules 344) based on with performance statuses 312 of the respective server 104 are to be determined, and any other data needed to performed operations of the single board computer 108A as described in embodiments of the present disclosure. The instructions 308 may include any suitable set of instructions, logic, rules, or code operable to execute the single board computer 108A.

The network interface 304 is configured to enable wired and/or wireless communications. The network interface 304 is configured to communicate data between the single board computer 108A and other devices, systems, or domains (e.g., the respective server where the single board computer 108A is deployed, network switches 106, central server 110 etc.). For example, the network interface 304 may include a Wi-Fi interface, a LAN interface, a WAN interface, a modem, a switch, or a router. The processor 302 is configured to send and receive data using the network interface 304. The network interface 304 may be configured to use any suitable type of communication protocol as would be appreciated by one of ordinary skill in the art.

In one or more embodiments, each single board computer 108A may be configured to monitor performance data 310 associated with the respective server 104 where the singe board computer 108A is deployed. Based on the performance data 310 of the respective server 104, the single board computer 108A may determine a performance status 312 of the respective server 104 wherein the performance status 312 indicates performance of respective server 104a. For example, single board computer 108A1 deployed at server 104a may be configured to monitor performance data 310 associated with server 104a and determine a performance status 312 of server 104a based on the performance data 310. For example, the network interface 304 of the single board computer 108A1 may communicate with a network interface of the server 104a and receive performance data from the server 104a. As shown in FIG. 3, performance statuses 312 associated with a server 104 may include, but are not limited to, “performance anomaly 314”, “no performance anomaly 316”, “security breach 318”, and “no security breach 320”. “Performance anomaly 314” indicates that the respective server 104 has experienced a performance anomaly. “No performance anomaly 316” indicates that the respective server has not experienced a performance anomaly. “Security breach 318” indicates that the server 104 has experienced a security breach. “No security breach 320” indicates that the server has not experienced a security breach.

In one or more embodiments, performance data 310 associated with a server 104a may include a plurality of performance metrics that indicate performance of the server 104, wherein the performance metrics include, but are not limited to, central processing unit (CPU) utilization, memory utilization, disk input/output (I/O), average processing load, response time, processing latency, or a combination thereof. In one or more embodiments, based on the performance data 310 of server 104a, single board computer 108A1 may determine a performance status 312 of the server 104a.

In one embodiment, single board computer 108A1 may implement rules 340 that allow translation of the performance data 310 into a particular performance status 312. For example, rules 340 may include several performance rules 342 that may define values of one or more performance metrics that indicate known performance anomalies. For example, a first rule may define that a CPU utilization that equals or exceeds a threshold indicates a performance anomaly 314. A second rule may define that a memory utilization that equals or exceeds a threshold indicates a performance anomaly 314. A third rule may define that a server response time that equals or exceeds a threshold indicates a performance anomaly 314. A fourth rule may define that disk I/Os that equal or exceed a threshold indicates a performance anomaly 314. A rule 340 may also define a performance anomaly based on a combination of performance metrics. For example, a fifth rule may define that when CPU utilization that equals or exceeds a threshold and memory usage that equals or exceeds a threshold, the server 104 has experienced a performance anomaly 314.

In one example use case, single board computer 108A1 may be configured to continuously (e.g., periodically or based on a pre-configured schedule) compare the performance metrics from the real-time performance data 310 collected from server 104a to the performance rules 342. When the performance data 310 matches with one or more performance rules 342, single board computer 108A1 sets the performance status 312 of the server 104a as “performance anomaly 314”. On the other hand, when the performance data 310 does not match with any performance rule 342, single board computer 108A1 sets the performance status 312 of the server 104a as “no performance anomaly 316”.

In an alternative or additional embodiment, performance data 310 may include metrics that indicate a security breach. For example, the performance data 310 may include an interaction log associated with each processing task performed by the server 104a, wherein each interaction log includes plurality of interaction parameters recording information processing task, wherein the interaction parameters may include, but are not limited to, identity of a user 112 or computing node that initiated the data interaction, authorization credentials (e.g., username, password etc.) of the user 112, a type of the data interaction (e.g., data access, data transfer etc.), a device ID of a computing node (e.g., user device) that was used to initiate the data interaction, an internet protocol (IP) address of the computing node, a network ID of the network (e.g., Local Area Network (LAN)) to which the computing node is connected to, device ID of a network router using which the computing node is communicating with the network 190, information (e.g., IP address) relating to intermediate computing nodes that are involved in performing the processing task, and any other information relating to processing of a processing task. In this context rules 340 may include several security rules 344 that may define values or patterns of one or more metrics from the performance data that indicate known security breaches. For example, a first security rule 344 may define that incorrect or unexpected results generated by server 104a indicates a security breach. A second security rule 344 may define that unexpected log entries indicate a security breach. A third rule may define that unusual access/login attempts indicate a security breach. A fourth rule may define that unauthorized data alteration indicates a security breach. A fifth rule may define that an antivirus intrusion alert indicates a security breach.

In one example use case, single board computer 108A1 may be configured to continuously (e.g., periodically or based on a pre-configured schedule) compare the metrics from the real-time performance data 310 collected from server 104a to the security rules 344. When the performance data 310 matches with one or more security rules 344, single board computer 108A1 sets the performance status 312 of the server 104a as “security breach 318”. On the other hand, when the performance data 310 does not match with any security rule 344, single board computer 108A1 sets the performance status 312 of the server 104a as “no security breach 320”.

Once the performance status 312 of the server 104a has been determined, single board computer 108A1 transmits the determined performance status 312 to network switch 106a associated with server group 120a. In one embodiment, single board computer 108A1 may be configured transmit the performance statuses 312 of server 104a to the network switch 106a in real time or near real time. Similarly, single board computers 108A2 and 108A3 continuously (e.g., periodically or based on a pre-configured schedule) determine performance statuses 312 of respective servers 104b and 104c and transmit the performance statuses 312 to network switch 106a in real time or near real time.

In one or more embodiments, each single board computer 108B deployed at a respective network switch 106 is configured to make decisions relating to routing processing requests 132 to servers 104 in the respective server group 120 based on processing statuses 312 reported by the servers 104 in the respective server group 120. For example, single board computer 108B deployed at network switch 106a is configured to route processing requests 132 for the first processing task 212 to servers 104a-c based on performance statuses 312 reported by the servers 104a-c.

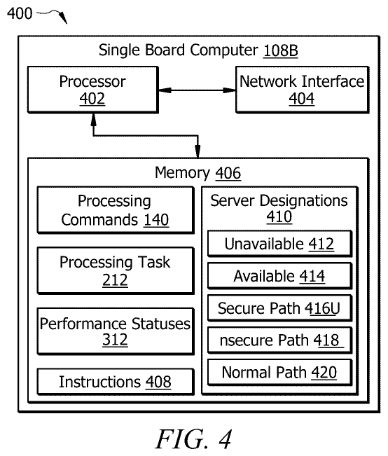

FIG. 4 illustrates an example schematic diagram 400 of a single board computer 108B deployed at a network switch 106 shown in FIG. 1, in accordance with one or more aspects of the present disclosure.

The single board computer 108B comprises a processor 402, a memory 406, and a network interface 404. The single board computer 108B may be configured as shown in FIG. 4 or in any other suitable configuration.

The processor 402 includes one or more processors operably coupled to the memory 406. The processor 402 is any electronic circuitry including, but not limited to, state machines, one or more central processing unit (CPU) chips, logic units, cores (e.g., a multi-core processor), field-programmable gate array (FPGAs), application specific integrated circuits (ASICs), or digital signal processors (DSPs). The processor 302 may be a programmable logic device, a microcontroller, a microprocessor, or any suitable combination of the preceding. The processor 402 is communicatively coupled to and in signal communication with the memory 406. The one or more processors are configured to process data and may be implemented in hardware or software. For example, the processor 402 may be 8-bit, 16-bit, 32-bit, 64-bit or of any other suitable architecture. The processor 402 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components.

The one or more processors are configured to implement various instructions, such as software instructions. For example, the one or more processors are configured to execute instructions 408 to implement the single board computer 108B. In this way, processor 402 may be a special-purpose computer designed to implement the functions disclosed herein. In one or more embodiments, the single board computer 108B is implemented using logic units, FPGAs, ASICs, DSPs, or any other suitable hardware. The single board computer 108B is configured to operate as described with reference to FIGS. 1, 4 and 5. For example, the processor 402 may be configured to perform at least a portion of method 500 as described with reference to FIG. 5.

The memory 406 includes a non-transitory computer-readable medium such as one or more disks, tape drives, or solid-state drives, and may be used as an over-flow data storage device, to store programs when such programs are selected for execution, and to store instructions and data that are read during program execution. The memory 406 may be volatile or non-volatile and may include a read-only memory (ROM), random-access memory (RAM), ternary content-addressable memory (TCAM), dynamic random-access memory (DRAM), and static random-access memory (SRAM).

The memory 406 is operable to store the instructions 408, processing task 212 performed by respective servers 104 served by the network switch 106 at which the single board computer 108B is deployed, processing commands 140 received from the central server 110, server designation 410 for each server 104 in the respective server group 120 served by the network switch 106 at which the single board computer 108B is deployed, and any other data needed to performed operations of the single board computer 108B as described in embodiments of the present disclosure. The instructions 408 may include any suitable set of instructions, logic, rules, or code operable to execute the single board computer 108B.

The network interface 404 is configured to enable wired and/or wireless communications. The network interface 404 is configured to communicate data between the single board computer 108B and other devices, systems, or domains (e.g., single board computers 108A deployed at servers 104, central server 110 etc.). For example, the network interface 404 may include a Wi-Fi interface, a LAN interface, a WAN interface, a modem, a switch, or a router. The processor 402 is configured to send and receive data using the network interface 404. The network interface 404 may be configured to use any suitable type of communication protocol as would be appreciated by one of ordinary skill in the art.

As described above, each single board computer 108B deployed at a respective network switch 106 is configured to make decisions relating to routing processing requests 132 to servers 104 in the respective server group 120 based on processing statuses 312 reported by the servers 104 in the respective server group 120. For example, single board computer 108B deployed at network switch 106a is configured to route processing requests 132 for the first processing task 212 (configured to be performed by servers 104 of server group 120a) to servers 104a-c based on performance statuses 312 reported by the servers 104a-c.

In an example use case, when network switch 106a receives a processing command 140 from central server 110 to perform the first processing task 212 the servers 104a-e of server group 120a are configured to perform, single board computer 108B1 deployed at the network switch 106a detects the processing command 140 and selects one of the servers 104a-c for performing the requested first processing task based on the respective performance statuses 312 of the servers 104a-c as received from each of the single board computers 108A1-3. In this context, single board computer 108B1 deployed at network switch 106a receives performance statuses 312 of each server 104a-c from the respective single board computers 108A1-3 and stores the received performance statuses 312 in memory 406. In one example, single board computer 108B1 may have previously assigned a server designation 410 of “normal path” to server 104a. This means that all processing requests 132 for the first processing task 212 are to be routed to server 104a. However, a processing status 312 of server 104a received from single board computer 108A1 at a later time may be set to “performance anomaly 314”. Based on this performance status 312, single board computer 108B1 may determine that server 104a has experienced a performance anomaly and may assign a server designation 410 of “unavailable 412” to server 104a. Essentially, single board computer 108B1 updates the server designation 410 of server 104a from “normal path 420” to “unavailable 412”. A server designation 410 of “unavailable” means that the server 104a is unavailable to processing requests 132 (e.g., perform first processing task 212). Once the server designation 410 of server 104a is set to “unavailable”, single board computer 108B1 causes the network switch 106a to stop transmitting processing requests 132 to server 104a.

In one or more embodiment, once the server 104a (which previously was the normal routing path for processing requests) is designated “unavailable”, single board computer 108B1 may be configured to select an alternative server 104 for routing subsequent processing requests 132. For example, single board computer 108B1 checks the server designations 410 of servers 104b and 104c and selects one of these two servers that have its server designation 410 set to “available 414”. A server designation 410 set to “available 414” means that the respective server 104 is available to perform the first processing task 212. In this context, single board computer 108B1 may be configured to assign a server designation 410 of “available” to a server 104 when the respective performance status 312 of the server 104 is set to “no performance anomaly 316”. For example, the latest performance status 312 of server 104b received from single board computer 108A2 may be set to “no performance anomaly 316”. In response, single board computer 108B1 may determine that server 104b has not experienced a performance anomaly and may assign a server designation 410 of “available 414” to server 104b. As the server designation 410 of server 104b is set to “available 414” to server 104b, single board computer 108B1 may select server 104b for processing subsequent processing requests 132. Thereafter, single board computer 108B1 may cause network switch 106a to transmit a processing request 132 to server 104b (e.g., instead of server 104a).

In one embodiment, single board computer 108B1 may additionally assign another server designation 410 of “normal path” to server 104b. This means that all subsequent processing requests 132 are to be transmitted to server 104b.

In one or more embodiments, single board computer 108B1 may be configured to quarantine a server 104 when the server has experienced a security breach. For example, a performance status 312 of server 104c received from single board computer 108A3 may be set to “security breach 318”. In response, single board computer 108B1 may determine that server 104c has experienced a security breach and may set the server designation 410 of server 104c to “unsecure path 418”. Once the server designation 410 of server 104c is set to “unsecure path 418”, single board computer 108B1 causes network switch 106a to quarantine server 104c, which includes stopping processing requests 132 or other data to be transmitted to server 104 and stopping data from being received from server 104c. In one embodiment, even when server 104c has a server designation 410 of “available 414” or “normal path 420”, if server 104c has another server designation 410 of “unsecure path 418”, server 104c is quarantined.

In an alternative example, a performance status 312 of server 104c received from single board computer 108A3 may be set to “no security breach 320”. In response, single board computer 108B1 may determine that server 104c has not experienced a security breach and may set the server designation 410 of server 104c to “secure path 416”. In one embodiment, when server 104 c has a first server designation 410 set to “available 414” and a second server designation 410 set to “secure path 416”, single board computer 108B1 assigns to server 104c a third server designation 410 of “normal path 420”. This means that single board computer 108B1 causes at least a portion of subsequent processing requests 132 to be routed to server 104c.

In one or more embodiments, single board computer 108A may assign multiple performance statuses 312 to a server 104. For example, based on performance data 310 of server 104c, single board computer 108A may assigned the performance statuses 312 of “no performance anomaly 316” and “security breach 318”. In another example, single board computer 108A may assigned the performance statuses 312 of “no performance anomaly 316” and “no security breach 320”. In this context, single board computer 108B1 deployed at network switch 106a may be configured to assign a server designation 410 of “available” to a server 104 when the respective performance status 312 of the server 104 is set to “no performance anomaly 316” and “no security breach 320”. For example, when performance statuses 312 of server 104c are assigned “no performance anomaly 316” and “no security breach 320”, single board computer 108B1 assigns a server designation 410 of “available 414” to server 104c. On the other hand, when performance statuses 312 of server 104c are assigned “no performance anomaly 316” and “security breach 318”, single board computer 108B1 assigns a server designation 410 of “unavailable 412” to server 104c.

In one or more embodiments, a single board computer 108A deployed at a respective server 104 may be configured to monitor performance data 310 associated with multiple servers 104 and assign performance statuses to each monitored server 104. The single board computer 108A may perform load balancing among the monitored servers 104 based on the performance statuses of the servers 104. For example, single board computer 108A3 deployed at server 104c may be configured to monitor performance data 310 of server 104c where it is deployed and additionally monitor performance data 310 of servers 104d and 104e. Single board computer 108A3 may be configured to forward at least a portion of processing requests 132 directed for server 104c to server 104d and/or 104c, in response to detecting that server 104c is overloaded.

For example, based on performance data 310 associated with server 104c, single board computer 108A3 may determine that server 104c is overloaded. For example, one or more of the CPU utilization, memory utilization and server response times associated with server 104c may equal or exceed respective thresholds, in response to which single board computer 108A3 may determine that server 104c is overloaded. Upon determining that server 104c is overloaded, single board computer 108A3 may forward at least a portion of processing requests 132 received at server 104c to server 104d and/or 104e, to ease the processing load on server 104c.

In one or more embodiments, at least a portion of network 190 may use optical communication for data transfer between computing nodes of the computing infrastructure 102. Optical communication generally includes transmitting data using optical (e.g., light) signals over optical wires/cables. For example, optical communications may be used for data communication between servers 104 and corresponding network switches 106. Since optical communication is generally much faster than traditional electrical communication, this means that performance statuses 312 reported by servers 104 reaches the respective network switches 106 in real time or near real time. This allows potential performance anomalies and security breaches to be detected and resolutions applied much quicker and before these issues become critical and damage the computing system.

In one or more embodiments, once single board computer 108B detects a performance anomaly or a security breach at a particular server 104a-c (e.g., based on performance status 312 reported by the particular server 104a-c) and has caused network switch 106a to route away processing requests 132 from the affected server 104a-c, the single board computer 108B may cause the network switch 106a to transmit the performance status 312 and/or server designation 410 of the affected server 104a-c to the central server 110. In response, central server 110 may apply a self-healing method to the affected server 104a-c to resolve the performance anomaly or the security breach and restore normal performance of at the affected server 104-c.

FIG. 5 illustrates a flowchart of an example method 500 for detecting and resolving performance anomalies and security breaches in a computing infrastructure 102, in accordance with certain embodiments of the present disclosure. Method 500 may be performed by the single board computers 108A and 108B as shown in FIG. 1.

At operation 502, a first single board computer 108A1 deployed at a first server 104a monitors performance data 310 of the first server 104a.

As described above, each single board computer 108A may be configured to monitor performance data 310 associated with the respective server 104 where the singe board computer 108A is deployed. Based on the performance data 310 of the respective server 104, the single board computer 108A may determine a performance status 312 of the respective server 104 wherein the performance status 312 indicates performance of respective server 104a. For example, single board computer 108A1 deployed at server 104a may be configured to monitor performance data 310 associated with server 104a and determine a performance status 312 of server 104a based on the performance data 310. For example, the network interface 304 of the single board computer 108A1 may communicate with a network interface of the server 104a and receive performance data from the server 104a. As shown in FIG. 3, performance statuses 312 associated with a server 104 may include, but are not limited to, “performance anomaly 314”, “no performance anomaly 316”, “security breach 318”, and “no security breach 320”. “Performance anomaly 314” indicates that the respective server 104 has experienced a performance anomaly. “No performance anomaly 316” indicates that the respective server has not experienced a performance anomaly. “Security breach 318” indicates that the server 104 has experienced a security breach. “No security breach 320” indicates that the server has not experienced a security breach.

In one or more embodiments, performance data 310 associated with a server 104a may include a plurality of performance metrics that indicate performance of the server 104, wherein the performance metrics include, but are not limited to, central processing unit (CPU) utilization, memory utilization, disk input/output (I/O), average processing load, response time, processing latency, or a combination thereof. In one or more embodiments, based on the performance data 310 of server 104a, single board computer 108A1 may determine a performance status 312 of the server 104a.

At operation 504, the first single board computer 108A1 determines a first performance status 312 of the first server 104a based on the performance data 310 relating to the first server 104a, wherein the first performance status 312 indicates performance of the first server 104a.

As described above, single board computer 108A1 may implement rules 340 that allow translation of the performance data 310 into a particular performance status 312. For example, rules 340 may include several performance rules 342 that may define values of one or more performance metrics that indicate known performance anomalies. For example, a first rule may define that a CPU utilization that equals or exceeds a threshold indicates a performance anomaly 314. A second rule may define that a memory utilization that equals or exceeds a threshold indicates a performance anomaly 314. A third rule may define that a server response time that equals or exceeds a threshold indicates a performance anomaly 314. A fourth rule may define that disk I/Os that equal or exceed a threshold indicates a performance anomaly 314. A rule 340 may also define a performance anomaly based on a combination of performance metrics. For example, a fifth rule may define that when CPU utilization that equals or exceeds a threshold and memory usage that equals or exceeds a threshold, the server 104 has experienced a performance anomaly 314.

In one example use case, single board computer 108A1 may be configured to continuously (e.g., periodically or based on a pre-configured schedule) compare the performance metrics from the real-time performance data 310 collected from server 104a to the performance rules 342. When the performance data 310 matches with one or more performance rules 342, single board computer 108A1 sets the performance status 312 of the server 104a as “performance anomaly 314”. On the other hand, when the performance data 310 does not match with any performance rule 342, single board computer 108A1 sets the performance status 312 of the server 104a as “no performance anomaly 316”.

At operation 506, the first single board computer 108A1 electronically transmits the first performance status 312 of the first server 104a to the first network switch 106a.

As described above, once the performance status 312 of the server 104a has been determined, single board computer 108A1 transmits the determined performance status 312 to network switch 106a associated with server group 120a. In one embodiment, single board computer 108A1 may be configured transmit the performance statuses 312 of server 104a to the network switch 106a in real time or near real time.

At operation 508, a second single board computer 108B1 deployed at the first network switch 106a electronically receives the first performance status 312 of the first server 104a from the first single board computer 108A1.

At operation 510, the second single board computer 108B1 receives a first request (e.g., processing command 140) to perform a first processing task 212 as part of a data interaction 210.

At operation 512, second single board computer 108B1 determines, based on the first performance status 312 of the first server 104a, whether the first server 104a has experienced a performance anomaly. If second single board computer 108B1 does not detect a performance anomaly at the first server 104a, method 500 proceeds to operation 516 where the second single board computer 108B causes the first network switch 106a to route the first request (e.g., processing command 140) to the first server 104a. On the other hand, if second single board computer 108B1 detects a performance anomaly at the first server 104a, method 500 proceeds to operation 518 where second single board computer 108B causes the first network switch 106a to route the first request (e.g., processing command 140) to a second server 104b that is also configured to perform the first processing task 212.

As described above, each single board computer 108B deployed at a respective network switch 106 is configured to make decisions relating to routing processing requests 132 to servers 104 in the respective server group 120 based on processing statuses 312 reported by the servers 104 in the respective server group 120. For example, single board computer 108B deployed at network switch 106a is configured to route processing requests 132 for the first processing task 212 (configured to be performed by servers 104 of server group 120a) to servers 104a-c based on performance statuses 312 reported by the servers 104a-c.

In an example use case, when network switch 106a receives a processing command 140 from central server 110 to perform the first processing task 212 the servers 104a-e of server group 120a are configured to perform, single board computer 108B1 deployed at the network switch 106a detects the processing command 140 and selects one of the servers 104a-c for performing the requested first processing task based on the respective performance statuses 312 of the servers 104a-c as received from each of the single board computers 108A1-3. In this context, single board computer 108B1 deployed at network switch 106a receives performance statuses 312 of each server 104a-c from the respective single board computers 108A1-3 and stores the received performance statuses 312 in memory 406. In one example, single board computer 108B1 may have previously assigned a server designation 410 of “normal path” to server 104a. This means that all processing requests 132 for the first processing task 212 are to be routed to server 104a. However, a processing status 312 of server 104a received from single board computer 108A1 at a later time may be set to “performance anomaly 314”. Based on this performance status 312, single board computer 108B1 may determine that server 104a has experienced a performance anomaly and may assign a server designation 410 of “unavailable 412” to server 104a. Essentially, single board computer 108B1 updates the server designation 410 of server 104a from “normal path 420” to “unavailable 412”. A server designation 410 of “unavailable” means that the server 104a is unavailable to processing requests 132 (e.g., perform first processing task 212). Once the server designation 410 of server 104a is set to “unavailable”, single board computer 108B1 causes the network switch 106a to stop transmitting processing requests 132 to server 104a.

In one or more embodiment, once the server 104a (which previously was the normal routing path for processing requests) is designated “unavailable”, single board computer 108B1 may be configured to select an alternative server 104 for routing subsequent processing requests 132. For example, single board computer 108B1 checks the server designations 410 of servers 104b and 104c and selects one of these two servers that have its server designation 410 set to “available 414”. A server designation 410 set to “available 414” means that the respective server 104 is available to perform the first processing task 212. In this context, single board computer 108B1 may be configured to assign a server designation 410 of “available” to a server 104 when the respective performance status 312 of the server 104 is set to “no performance anomaly 316”. For example, the latest performance status 312 of server 104b received from single board computer 108A2 may be set to “no performance anomaly 316”. In response, single board computer 108B1 may determine that server 104b has not experienced a performance anomaly and may assign a server designation 410 of “available 414” to server 104b. As the server designation 410 of server 104b is set to “available 414” to server 104b, single board computer 108B1 may select server 104b for processing subsequent processing requests 132. Thereafter, single board computer 108B1 may cause network switch 106a to transmit a processing request 132 to server 104b (e.g., instead of server 104a).

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system comprising:
a first server configured to perform a first processing task;
a second server, also configured to perform the first processing task;
a first network switch communicatively coupled to the first server and the second server, wherein the first network switch is configured to route processing requests for the first processing task to the first server and the second server;
a first single board computer deployed at the first server, wherein the first single board computer is an independent processing entity from the first server;
a second single board computer deployed at the second server, wherein the second single board computer is an independent processing entity from the second server; and
a third single board computer deployed at the first network switch, wherein the third single board computer is an independent processing entity from the first network switch;
a first processor of the first single board computer deployed at the first server configured to:
monitor performance data indicating performance of the first server;
determine a first performance status of the first server based on the performance data relating to the first server, wherein the first performance status indicates performance of the first server; and
electronically transmit the first performance status of the first server to the first network switch;
a second processor of the third single board computer deployed at the first network switch configured to:
electronically receive the first performance status of the first server from the first single board computer deployed at the first server;
receive a first request to perform the first processing task as part of a first data interaction;
determine, based on the first performance status of the first server, that the first server has experienced a performance anomaly; and
in response to determining that the first server has experienced the performance anomaly, cause the first network switch to route the first request to the second server that is also configured to perform the first processing task.

2. The system of claim 1, wherein:
a third processor of the second single board computer deployed at the second server is configured to:
monitor the performance data indicating performance of the second server;
determine a second performance status of the second server based on the performance data relating to the second server, wherein the second performance status indicates performance of the second server; and
electronically transmit the second performance status of the second server to the first network switch;
the second processor of the third single board computer deployed at the first network switch is further configured to:
electronically receive the second performance status of the second server from the second single board computer deployed at the second server; and
determine, based on the second performance status of the second server, that the second server has not experienced the performance anomaly;
wherein causing the first network switch to route the first request to the second server is in response to determining that the second server has not experienced the performance anomaly.

3. The system of claim 1, further comprising:
a third server communicatively coupled to the second server, wherein the third server is also configured to perform the first processing task;
wherein a third processor of the second single board computer deployed at the second server is configured to:
monitor the performance data indicating performance of the second server;
determine, based on the performance data associated with the second server, a second performance status of the second server indicating that the second server is overloaded; and
in response to determining that the second server is overloaded, routing at least a portion of processing requests received at the second server to the third server also configured to perform the first processing task.

4. The system of claim 3, wherein the second single board computer deployed at the second server monitors the performance data associated with the second server and the third server.

5. The system of claim 1, further comprising:
a third server communicatively coupled to the first network switch, wherein the third server is also configured to perform the first processing task; and
a fourth single board computer deployed at the third server, wherein the fourth single board computer is an independent processing entity from the third server;
wherein:
the first network switch is configured to further route the processing requests for the first processing task to the third server;
a third processor of the fourth single board computer deployed at the third server is configured to:
determine, based on the performance data associated with the third server, a second performance status of the third server indicating that the third server has experienced a security breach; and
electronically transmit the second performance status of the third server to the first network switch;
the second processor of the third single board computer deployed at the first network switch is further configured to:
determine, based on the second performance status of the third server that the third server has experienced the security breach;
in response to determining that the third server has experienced the security breach, designate the third server as an unsecure network path; and
cause the first network switch to quarantine the third server, wherein the quarantine comprises stopping the processing requests and data to be transmitted to and received from the third server.

6. The system of claim 1, further comprising:
a third server communicatively coupled to the first network switch, wherein the third server is also configured to perform the first processing task; and
a fourth single board computer deployed at the third server, wherein the fourth single board computer is an independent processing entity from the third server;
wherein:
the first network switch is configured to further route the processing requests for the first processing task to the third server;
a third processor of the fourth single board computer deployed at the third server is configured to:
determine, based on the performance data associated with the third server, a second performance status of the third server indicating that the third server has not experienced a security breach; and
electronically transmit the second performance status of the third server to the first network switch;
the second processor of the third single board computer deployed at the first network switch is further configured to:
determine, based on the second performance status of the third server that the third server has not experienced a security breach;
in response to determining that the third server has not experienced the security breach, designate the third server as a secure network path; and
cause the first network switch to route at least a portion of subsequent processing requests to the third server.

7. The system of claim 1, wherein the third single board computer deployed at the first network switch communicates with each of the first single board computer deployed at the first server and the second single board computer deployed at the second server using optical signals.

8. A method comprising:
monitoring, by a first single board computer deployed at a first server, performance data indicating performance of the first server;
determining, by the first single board computer, a first performance status of the first server based on the performance data relating to the first server, wherein the first performance status indicates performance of the first server;
electronically transmitting, by the first single board computer, the first performance status of the first server to a first network switch;
electronically receive, at a second single board computer deployed at the first network switch, the first performance status of the first server from the first single board computer deployed at the first server;
receiving, by the second single board computer, a first request to perform a first processing task as part of a first data interaction;
determining, by the second single board computer, based on the first performance status of the first server, that the first server has experienced a performance anomaly; and
in response to determining that the first server has experienced the performance anomaly, causing, by the second single board computer, the first network switch to route the first request to a second server that is also configured to perform the first processing task.

9. The method of claim 8, further comprising:
monitoring, by a third single board computer deployed at the second server, the performance data indicating performance of the second server;
determining, by the third single board computer deployed at the second server, a second performance status of the second server based on the performance data relating to the second server, wherein the second performance status indicates performance of the second server;
electronically transmitting, by the third single board computer deployed at the second server, the second performance status of the second server to the first network switch;
electronically receiving, by the second single board computer, the second performance status of the second server from the third single board computer deployed at the second server; and
determining, by the second single board computer, based on the second performance status of the second server, that the second server has not experienced the performance anomaly;
wherein causing the first network switch to route the first request to the second server is in response to determining that the second server has not experienced the performance anomaly.

10. The method of claim 8, further comprising:
monitoring, by a third single board computer deployed at the second server, the performance data indicating performance of the second server;
determining, by the third single board computer deployed at the second server, based on the performance data associated with the second server, a second performance status of the second server indicating that the second server is overloaded;
in response to determining that the second server is overloaded, routing, by the third single board computer deployed at the second server, at least a portion of processing requests received at the second server to a third server also configured to perform the first processing task.

11. The method of claim 10, wherein the third single board computer deployed at the second server monitors the performance data associated with the second server and the third server.

12. The method of claim 8, further comprising:
determining, by a fourth single board computer deployed at a third server, based on the performance data associated with the third server, a second performance status of the third server indicating that the third server has experienced a security breach; and
electronically transmitting, by the fourth single board computer, a second performance status of the third server to the first network switch;
determining, by the second single board computer deployed at the first network switch, based on the second performance status of the third server that the third server has experienced the security breach;
in response to determining that the third server has experienced the security breach, designating, by the second single board computer, the third server as an unsecure network path; and
causing, by the second single board computer, the first network switch to quarantine the third server, wherein the quarantine comprises stopping the processing requests and data to be transmitted to and received from the third server.

13. The method of claim 8, further comprising
determining, by a fourth single board computer deployed at a third server, based on the performance data associated with the third server, a second performance status of the third server indicating that the third server has not experienced a security breach; and
electronically transmitting, by the fourth single board computer, the second performance status of the third server to the first network switch;
determining, by the second single board computer deployed at the first network switch, based on the second performance status of the third server that the third server has not experienced a security breach;
in response to determining that the third server has not experienced the security breach, designating, by the second single board computer, the third server as a secure network path; and
causing, by the second single board computer, the first network switch to route at least a portion of subsequent processing requests to the third server.

14. A system comprising:
a plurality of servers, wherein each server is configured to perform a particular processing task;
a plurality of network switches, wherein each network switch is associated with a respective group of the servers that perform the particular processing task and is configured to route processing requests to the respective group of the servers; and
a single board computer deployed at each of the servers and each of the network switches, wherein each single board computer is an independent processing entity from the respective server or network switch at which the single board computer is deployed;
each single board computer, deployed at each of the servers of a first group of servers configured to perform a same first processing task, comprises a first processor configured to:
monitor performance data indicating performance of the respective server at which the single board computer is deployed;
determine a performance status of the respective server based on the performance data relating to the respective server, wherein the performance status indicates performance of the respective server; and
electronically transmit the performance status of the respective server to a first network switch of the plurality of network switches that is configured to route data to the first group of servers;
a first single board computer deployed at the first network switch comprises a second processor configured to:
electronically receive the performance status from each of the single board computers deployed at each server of the first group of servers that are configured to perform the same first processing task;
receive a first request to perform the same first processing task as part of a first data interaction;
determine, based on the performance status relating to a first server of the first group of servers, that the first server has experienced a performance anomaly; and
in response to determining that the first server has experienced the performance anomaly, cause the first network switch to route the first request to a second server of the first group of servers that is also configured to perform the same first processing task.

15. The system of claim 14, wherein the second processor of the first single board computer deployed at the first network switch is further configured to:
determine, based on the performance status relating to the second server of the first group of servers, that the second server has not experienced the performance anomaly;
wherein causing the first network switch to route the first request to the second server is in response to determining that the second server has not experienced the performance anomaly.

16. The system of claim 14, wherein the first processor of the single board computer deployed at the second server of the first group of servers is further configured to:
determine, based on the performance data associated with the second server, the performance status of the second server indicating that the second server is overloaded; and
in response to determining that the second server is overloaded, route at least a portion of processing requests received at the second server to a third server of the first group of servers.

17. The system of claim 16, wherein the single board computer deployed at the second server monitors the performance data associated with the second server and the third server.

18. The system of claim 14, wherein:
the first processor of the single board computer deployed at a third server of the first group of servers is further configured to:
determine, based on the performance data associated with the third server, the performance status of the third server indicating that the third server has experienced a security breach; and
electronically transmit the performance status of the third server to the first network switch of the plurality of network switches that is configured to route data to the first group of servers;
the second processor of the first single board computer deployed at the first network switch is further configured to:
determine, based on the performance status of the third server that the third server has experienced the security breach;
in response to determining that the third server has experienced the security breach, designate the third server as an unsecure network path; and
cause the first network switch to quarantine the third server, wherein the quarantine comprises stopping processing requests and data to be transmitted to and received from the third server.

19. The system of claim 14, wherein:
the first processor of the single board computer deployed at a third server of the first group of servers is further configured to:
determine, based on the performance data associated with the third server, the performance status of the third server indicating that the third server has not experienced a security breach; and
electronically transmit the performance status of the third server to the first network switch of the plurality of network switches that is configured to route data to the first group of servers;
the second processor of the first single board computer deployed at the first network switch is further configured to:
determine, based on the performance status of the third server that the third server has not experienced a security breach;
in response to determining that the third server has not experienced the security breach, designate the third server as a secure network path; and
cause the first network switch to route at least a portion of subsequent processing requests to the third server.

20. The system of claim 14, wherein the first single board computer deployed at the first network switch communicates with each of the single board computers deployed at the respective servers using optical signals.
